(19) United States
(12) Patent Application Publication
(10) Pub. No.: US 2003/0157312 A1
(43) Pub. Date: Aug. 21, 2003

(54) Processed board-type products made of non-wooden fibers

(76) Inventor: Naganori Sagawa, Kyoto (JP)

Correspondence Address: JORDAN AND HAMBURG LLP, 122 EAST 42ND STREET, SUITE 4000, NEW YORK, NY, 10168, US

(21) Appl. No.: 10/380,781

(22) PCT Filed: Sep. 18, 2001
(86) PCT No.: PCT/JP01/08113

(30) Foreign Application Priority Data
Sep. 18, 2000 (JP) 2000-324756

(51) Int. Cl. D04H 5/00; B32B 3/26

(52) U.S. Cl. 428/311.11; 442/327; 428/304.4; 428/311.71; 428/904.4

(57) ABSTRACT

To provide a typically plate-shaped or sheet-shaped inexpensive web product that is prepared on a large scale and using cheaper raw materials that have not been used, with the web being tenacious and non-toxic when used as construction parts of houses, and capable of being discarded under the ground so as to be readily decomposed by bacteria and enzymes, and further capable of being burnt at lower temperatures preventing generation of toxic substances.

The web is made from a non-woody fiber pulp that is any one of fibers originating from gramineous, palmaceous and polygonaceous plants, or any mmixture of them. The graimineous plants are of a self-reproducing nature and the polygonaceous plants are any buckwheat. The web of this composition is rendered sheet-shaped before hot-pressed or dried to give concrete formwork articles, wallpapers or the coverings for Japanese sliding doors.

### DETAILED DESCRIPTION OF INVENTION

1. Field of the Invention

The present invention relates to building materials and papery covering sheets that are produced by papering a composite material whose principal ingredients are nonwoody fibers.

2. Prior Art

Papers have been the most typical examples of plate-shaped or sheet-shaped products made from woody fibers. Among them, Japan papers have been made by collecting the bast fibers of shrubs such as Broussonetia kajinoki (viz., “kohzo” in Japanese) and Edgeworthia papyriferas (viz., “mitsumata” in Japanese) and adding them a proper amount of binder (viz. a sizing agent). Other papers for use in offices or as the packaging materials are provided inexpensively by mass-production. In this general case, needle-leaf trees and/or broadleaf trees are ground at first into chips and then alkaline-digested to give a pulp. The pulp will be disintegrated in water into constituent fibers, before they are blended with amounts of the sizing agent (i.e., binder) and some additives during the papermaking process. Thinner papers thus produced will be used as wallpapers or as other interior finish materials like fusuma (viz., Japanese sliding doors), with thicker and more rigid papers being sometimes pressed together with auxiliary materials or otherwise processed to give certain types of fiber boards or the like.

Problems to be Resolved

Japan papers made from the raw materials noted above may be advantageous when used to make buildings, because longer fibers afford them a higher tenacity. However, it is considerably difficult to obtain a large lot of raw fibrous materials for such Japan papers, thus disabling inexpensive mass-production of them and delimiting their utility. In contrast, other modern papers made of wood pulps are adapted to mass production, although an enormous number of woods have to be felled and great quantities of chemical reagents are required. These conditions are undesirable to the earth from environmental and ecological points of view. Further, such modern papers are weaker in mechanical strength as compared with Japan papers, thereby rendering impossible their usage as constructive parts of the concrete depositing formworks.

The present invention was made to resolve the described problems, and its primary object is to provide a nonwoody fiber web that somewhat resembles ordinary papers and is capable of mass-production using such inexpensive botanical materials that have scarcely been used heretofore or have not been used at all. The web provided herein has to be stronger, more tenacious and cheaper so that it may qualify not only as concrete formworks and the like but also as safe and non-hazardous interior finish materials in buildings. When the web is discarded and buried under the ground, it should be decomposed readily in a short time by bacteria and/or enzymes, and even if the web is burnt, it should not generate any toxic substances.

Means for Achiving the Objects

In order to achieve the object, a nonwoody fiber web may be made by the papermaking process and using a pure pulp of fibers originating from any one of gramineous plants, palmaceous plants and polygonaceous plants, or using a mixed pulp of the fibers originating from any two or more of these plants. The gramineous plants may be of a self-reproducing nature, and the polygonaceous plants may be any buckwheat.

From a second aspect of the invention, the pulp of nonwoody fibers originating from gramineous, palmaceous and/or polygonaceous plants may contain at least 70% by weight of bamboo fibers.

From a third aspect, the nonwoody fiber web made from such a pulp may be a formwork piece for use in the concrete depositing.

From a fourth aspect, the nonwoody fiber web made from such a pulp may be a wallpaper or the like papery covering sheet.

The Preferred Embodiments

As summarized above, the nonwoody but botanical fiber web will be composed of any one of or of any mixture of gramineous plant fibers, palmaceous plant fibers and polygonaceous plant fibers. The gramineous plants of a self-regenerating nature include bamboos, ditch reed, Indian corn, wheats, Chinese millet, kaoliang and the like. The palmaceous and polygonaceous plants include palm trees and buckwheats, respectively. Their nonwoody fibers may be isolated from their trunks, stems, barks, skins, leaves, stalks, cores and/or the like. At first, these fibrous materials will be ground into chips or into powdery particles so as to prepare a powdery pulp and/or a sheet pulp, by the papermaking or web-making method. Thus, three kinds of powdery and/or sheet pulps are prepared corresponding to the three raw materials so that any one of them is solely used or any mixture of them of a desired mixing ratio is used. These pulps will then be thrown into a dissolving water tank, without or with any natural sizing agent such as a paste, a starch or a seaweed size being added to the pulps. Ratio of the added sizing agent is selected within a range of from 0% to about 5% by weight, taking into account the final usage of product, and these ingredients will thus be stirred within the tank to give a pulp slurry. In some cases wherein the intermediate pulp products need not be stored, they may be directly fed into the slurry tank, immediately after extracted from the botanical raw materials. If the powdery pulp is composed of fine fibrous particles of a size passing a 150 to 200 mesh-sieve, about 20% by weight of additional pulp from lumbers delivered for a forest by the thinning thereof may be added to the slurry. However, final products in this case will inevitably be inferior to other types of products, with respect to mechanical strength.

A still wet layer of such a powdery or sheet pulp from the nonwoody fiber slurry will then be pressed to form a plate-like product. The wet layer or web to be pressed may preferably contain about 70% by weight or more of a supplementary pulp of longer fibers, if the concrete formwork pieces of a sufficient strength have to be produced. A bamboo pulp may be most recommendable as such a supplementary pulp, and the pressure of about 1 to 40 kg/cm² will be applied to such a web may be.

In a case wherein a wallpaper or any other interior finish sheet such as the paper forming a Japanese sliding door “fusuma”, a sheet-like article of a predetermined size and shape will be produced. A wet intermediate sheet may be subjected merely to the rolling treatment thereof, if this article is to be finally about 0.2 to 1.0 mm thick. A dense slurry of non-woody pulp may be applied to a core plate and dried thereon to produce the interior finish product in an alternative manner.

Generally, each species included in the bamboo subfamily of gramineous plants is composed much longer fibers than other species belonging to the other subfamilies. Bamboos thus useful to enhance strength of the paper products are less likely to become moldy and are of a highly antibacterial nature. More than 30% (more preferably more than 70%) by weight of bamboo fibers contained in the interior finish sheets will be effective to keep rooms remarkably hygienic.

If a moderately lower pressure is applied to the sheet-like web that is being manufactured in accordance with the method proposed herein, it will serve to automatically control the relative humidity of a room. In the event that the room air would tend to become excessively wet, the web will absorb a noticeable amount of moisture out of the ambient air to prevent the relative humidity from undesirably rising within the room. In the contrary event, the web will desorb an amount of moisture and return it into the room to inhibit it from getting excessively dried. The web used as the interior finish sheets is composed only of natural materials free from any amount of formaldehyde or any other toxic substances, so that respiratory organs of the residents in such a room will be protected from suffering from the so-called sick-house syndrome. The web's ability of automatically controlling the room humidity in a case of its internal texture similar to that of the raw pulp will be about twice as high as that in another case of being finished as a rigid paper.

The gramineous, palmaceous and polygonaceous nonwooden fibers forming the concrete formwork pieces or the wall pulp or “fusuma” pulp as in the Examples given below are all much longer than the conventional wooden fibers. Therefore, the web of the invention has a tensile strength that is about twice to thrice as high as that of the ordinary papers. Thanks to this feature, the web can be used to form a variety of commercial products that have been made of certain inorganic materials or certain petroleum materials other than papers.

Further, each web of the invention consists only of natural materials, so that any waste of the web used and worn can be burnt at lower temperatures, without any fear of damaging a waste-burning oven and free from the problem of emitting dioxines. If buried under the ground, it will be biologically decomposed by underground bacteria and/or enzymes so as to serve thereafter as a kind of organic fertilizer or soil conditioner, thus contributing to environmental hygiene.

### EXAMPLES

Now some examples will be described making reference to the embodiments as summarized above.

### # First Example

A concrete formwork piece was prepared by at first shredding bamboo's trunks, stems, barks, cores and the like to prepare a powder or sheet-shaped pulp. 5 kiloliters of water was added to 3 kilograms of this pulp within a dissolving tank to form a mixture, which was then stirred to provide a fiber slurry. 5% (with respect to weight of the pulp) of a seaweed size was added to and intermixed well with the slurry, before sieving it through a screening net to provide a wet web. Subsequently, this web was pressed at a pressure of 5 kg/cm² to give the formwork piece as the first example, with the piece showing a density of 0.1 kg/m².

### # Second Example

A wallpaper or a covering paper for the Japanese sliding door (viz., fusuma) was produced as a sheet-shaped product according to the second example. Waste of bamboo stems was processed to give 2.1 Kg of a first pulp, and coconut skins were processed to give 0.9 Kg of a second pulp. A slurry was prepared by mixing the pulps, with 5 kiloliters of water being added thereto within a dissolving tank. Subsequently, 1% by weight (with respect to the pulp) of a gelatin as the sizing agent was added to the resultant slurry, before making a wet web as in the usual papermaking process. A hot roller was then used to press and dry the wet web to give a finished sheet having a thickness of 0.5 mm and density of 0.1 kg/m². This sheet-shaped product proved satisfactory in all properties inclusive of strength, protection from getting moldy, antibacterial nature, self-control of moisture, no emission of toxic gases, and so on. Sheet's density (reflecting its thickness) and the rolling pressure may be adjusted to optimize its feeling of touch and its appearance, so as to match its usage as any articles other than the wallpaper or fusuma paper, for example its usage as curtains or the like coverings for house rooms or for automobile cabins.

In the second example, bamboo fiber as one of the typical gramineous fibers was used together with the coconut skin fibers. However, ditch reed fiber as a further gramineous plant may solely or in addition to buckwheat fiber as one of polygonaceous plants be added to them. Any other natural size originating from seaweed may be used in place of gelatin, possibly changing its feeling of touch and its quality such as self-control of moisture, but without adversely affecting its high strength, wherein the rolling pressure is modified to optimize its overall property.

### # Third Example

This example does also relate to a wallpaper pulp or a covering paper for pulp the Japanese sliding door (viz., fusuma). However, they were not finished to be any solid sheet but was provided as dense paste-like slurries such that they could be spread over each rigid planer core before dried and solidified to directly form a hard covering thereon. Density of such a paste-like pulp may be adjusted depending upon the covering's desired thickness of for instance about 0.5 mm and taking into account the application thickness of said paste. Advantages similar to those which the second example provides are also afforded, but with the capability of selfcontrolling humidity being much more improved by virtue of such a non-pressed state of the paste type pulp. Blend ratio of the constituent fibers may be designed similarly to that described in the second example.

Some representative embodiments and examples are described above, although they may be modified in varied manners insofar as any similar elements or components are employed to achieve the object of invention and to afford the same effects and advantages as summarized below.

Advantages Afforded Herein

The nonwoody fiber web typically sheet- or plate shaped and made of a pulp that is composed of any one of fibers, or any mixture thereof, originating from gramineous, palmaceous and polygonaceous plants. The gramineous plants are of a self-reproducing nature and the polygonaceous plants are any buckwheat, and all kinds of these plants are so cheap that they have not been utilized but discarded wastefully. Major of the fibers of such a plant are so long that the product provided herein is of a higher tensile strength and a higher tenacity.

The papers made from such nonwoody fibers are capable of varying their moisture content depending upon relative humidity of ambient air, in such a manner that said humidity will automatically be kept in a moderate range. The natural fibers are not likely to generate any toxic gases, and the fibers of bamboos belonging to the gramineous family are of antibacterial and mold-killing properties so that respiratory organs are protected well from the “sick-house” syndrome.

When the web products are discarded after use, they can not only be burnt at such low temperatures as protecting the oven or furnace from damage, be damaged, but also be buried under the ground to be effectively decomposed by bacteria and/or enzymes so as to serve as a kind of fertilizer and/or soil conditioner. Therefore, many of conventional inorganic raw materials and many petroleum materials can now be replaced advantage ously with the web product of the invention to manufacture a variety of articles.

1] A nonwoody fiber web made of a pulp that is composed of any one of fibers, or any mixture thereof, originating from gramineous plants, palmaceous plants and polygonaceous plants, wherein the gramineous plants are of a self-reproducing nature and the polygonaceous plants are any buckwheat.

2] A nonwoody fiber web as defined in claim 1, wherein the gramineous plants are any bamboo whose fiber is contained at 70% or more by weight of the pulp.

3] A nonwoody fiber web as defined in claim 1, wherein the web is a formwork piece for use in the concrete depositing.

4] A nonwoody fiber web as defined in claim 1, wherein the web is a wallpaper or the like papery covering sheet.
